(19) United States
(12) Patent Application Publication
(10) Pub. No.: US 2025/0169640 A1
(43) Pub. Date: May 29, 2025

(54) DEVICES AND SYSTEMS FOR EXTRACTION OF PLANT INFUSION MATERIAL

(71) Applicant: Teaspressa, LLC, Tempe, AZ (US)

(72) Inventors: Allison DeVane, Phoenix, AZ (US); Gene Bunger, Phoenix, AZ (US)

(21) Appl. No.: 18/519,914

(22) Filed: Nov. 27, 2023

(51) Int. Cl. A47J 31/20

(52) U.S. Cl. CPC A47J 31/20

(57) ABSTRACT

Systems and devices for creating an infused liquid, for example using tea leaves, including a vessel having a base and a wall extending up from the base to a first height, wherein an interior surface of the wall defines a substantially cylindrical internal volume having a first diameter and substantially the first height and an exterior surface of the wall has a second diameter at an upper extent of the wall and a third diameter proximate to the base, wherein the third diameter is greater than the second diameter and the exterior surface of the wall gradually increases in diameter from the second diameter to the third diameter. The first height may be less than the first diameter. The vessel may have a spout and handle. The systems and devices may comprise a lid for the vessel, a plunger through the lid, and a strainer assembly coupled with the plunger.

### FIELD

The following discussion generally relates to equipment and methods for making infused beverages. More particularly, it relates to French Press type steeping devices and methods for making the same.

### BACKGROUND

Infusion devices such as French Press type devices may be used to make infused beverages, such as coffee and tea. French Press devices typically require placing an infusion material, such as tea leaves, ground coffee, or the like, in a container along with a liquid such as hot water, then allowing the mixture to brew (steep) for a certain amount of time, pressing the infusion material to the bottom of the container using a strainer that is plunged through the liquid via a rod connected through a lid of the container, and pouring the strained infused liquid into a separate container such as a drinking cup.

When pressing the strainer to the bottom of a French Press type device, the infusion materials can become compacted between the bottom of the strainer and the bottom of the container and may release unwanted flavors and/or fine particles and sediment into the infused liquid. Certain plant infusion material, such as dried tea leaves, ground coffee, and other herbal mixtures may release undesirable bitter flavors when compressed. With some typical tall and narrow French Press devices, the infusion materials are concentrated under the strainer and can be easily over-compressed, leading to a poorly flavored infused liquid. With other typical tall and narrow French Press devices, the strainer is stopped well short of the container bottom to avoid compressing the infusion materials, with the negative consequence of making it more difficult to create a smaller amount of infused liquid (with a large amount of the desired infused liquid remaining below the strainer). In addition, typical French Press devices constrain the infusion materials to a narrow column, preventing for example dried tea leaves and other dried plant materials from spreading out and unfurling during the infusion process which leads to a suboptimal infusion of the liquid.

It is therefore desirable to create improved devices and systems for extraction of infusion material. Other desirable features and characteristics will become apparent from the subsequent detailed description and the appended claims, taken in conjunction with the accompanying drawings and this background section.

### SUMMARY

The aforementioned shortcomings can be overcome by providing systems and devices for extraction of infusion material according to the present disclosure.

In one aspect, the present disclosure provides a system for creating an infused liquid. The system includes a vessel having a base and a wall extending upwardly from the base to a first height, wherein an interior surface of the wall is substantially vertical and defines a cylindrical internal volume having a first diameter and substantially the first height. The vessel includes a spout at an upper portion of the wall and a handle on an exterior surface of the wall, and an exterior surface of the wall has a second diameter substantially at an upper extent of the wall and a third diameter proximate to the base. The third diameter is greater than the second diameter, and the exterior surface of the wall gradually increases in diameter from the second diameter to the third diameter. The system further includes a strainer assembly including a mesh filter, wherein the strainer assembly is configured to be inserted within the internal volume and wherein a diameter of the mesh filter is configured to be received by the internal volume, a plunger rod having a first end and a second end wherein the first end is coupled with the strainer assembly, and a lid configured to removably couple with the wall near the upper extent of the wall wherein the lid includes an opening slidably coupled with the plunger rod.

In another aspect, the present disclosure provides a device for creating an infused liquid. The device includes a vessel having a base and a wall extending upwardly from the base to a first height, wherein an interior surface of the wall is substantially vertical and defines a cylindrical internal volume having a first diameter and substantially the first height. The vessel includes a spout at an upper portion of the wall and a handle on an exterior surface of the wall, and an exterior surface of the wall has a second diameter substantially at an upper extent of the wall and a third diameter proximate to the base. The third diameter is greater than the second diameter, and the exterior surface of the wall gradually increases in diameter from the second diameter to the third diameter.

In another aspect, the present disclosure provides a device for creating an infused liquid. The device includes a vessel having a base and a wall extending upwardly from the base to a first height, wherein an interior surface of the wall is substantially vertical and defines a cylindrical internal volume having a first diameter and substantially the first height. An exterior surface of the wall includes a first frustoconical surface and includes a second diameter at a top of the wall and a third diameter at a bottom of the wall, wherein the second diameter is smaller than the third diameter. An exterior surface of the base includes a second frustoconical surface and includes the third diameter at a top of the base and a fourth diameter at a bottom of the base, wherein the fourth diameter is small than the third diameter and wherein the first frustoconical surface transitions to the second frustoconical surface at the third diameter. The vessel includes a spout at an upper portion of the wall and a handle on an exterior surface of the wall, and the first height is less than the first diameter.

The foregoing and other aspects and advantages of the disclosure will appear from the following description. In the description, reference is made to the accompanying drawings which form a part hereof, and in which there is shown by way of illustration preferred configurations of the disclosure. Such configurations do not necessarily represent the full scope of the disclosure, however, and reference is made therefore to the claims and herein for interpreting the scope of the disclosure.

### BRIEF DESCRIPTION OF DRAWINGS

FIG. 1A illustrates an upper perspective view of an exemplary system for creating an infused liquid, according to various embodiments.

FIG. 1B illustrates a side cross section through a handle and spout of the system for creating an infused liquid, according to various embodiments.

FIG. 1C illustrates a lower perspective view of the system for creating an infused liquid, according to various embodiments.

FIG. 1D illustrates an upper perspective view of a transparent infusion device, according to various embodiments.

FIG. 1E illustrates an upper perspective view of an opaque infusion device, according to various embodiments.

FIG. 1F illustrates an upper perspective view of an alternative infusion device, according to various embodiments.

FIG. 2 illustrates an upper perspective view of an infusion device, according to various embodiments.

FIG. 3A illustrates a left side view of an infusion device, according to various embodiments.

FIG. 3B illustrates a back view of the system for creating an infused liquid, according to various embodiments.

FIG. 3C illustrates a back view of an infusion device, according to various embodiments.

FIG. 3D illustrates a front view of the system for creating an infused liquid, according to various embodiments.

FIG. 3E illustrates a front view of an infusion device, according to various embodiments.

FIG. 3F illustrates a top view of an infusion device, according to various embodiments.

FIG. 3G illustrates a bottom view of an infusion device, according to various embodiments.

FIG. 4A illustrates a left side view of an alternative infusion device having a first exemplary handle, according to various embodiments.

FIG. 4B illustrates a partial left side view of an alternative infusion device having a second exemplary handle, according to various embodiments.

FIG. 4C illustrates a left side view of the system for creating an infused liquid, according to various embodiments.

FIG. 4D illustrates a top view of the system for creating an infused liquid, according to various embodiments.

FIG. 4E illustrates a bottom view of the system for creating an infused liquid, according to various embodiments.

FIG. 5A illustrates a side view of a lid of the system for creating an infused liquid, according to various embodiments.

FIG. 5B illustrates a top view of the lid of the system for creating an infused liquid, according to various embodiments.

FIG. 5C illustrates a perspective view of the lid of the system for creating an infused liquid, according to various embodiments.

FIG. 6A illustrates a top view of a knob of a plunger assembly, according to various embodiments.

FIG. 6B illustrates a side view of a knob of a plunger assembly, according to various embodiments.

FIG. 6C illustrates a perspective view of a knob of a plunger assembly, according to various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

The detailed description of exemplary embodiments herein makes reference to the accompanying drawings which show exemplary embodiments by way of illustration. While these exemplary embodiments are described in sufficient detail to enable those skilled in the art to practice the inventions, it should be understood that other embodiments may be realized and that logical, chemical, and mechanical changes may be made without departing from the spirit and scope of the inventions. For example, any steps recited herein in a method description may be executed in any order (unless otherwise specified) and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, integral, continuous, contiguous, and/or any other possible attachment option. Additionally, any reference to without contact (or similar phrases) may also include reduced contact or minimal contact.

Devices and systems for extraction of plant infusion material according to various embodiments as described herein may provide an improved French Press type system for making infused liquids. According to various embodiments, a vessel for creating the infused liquid provides an infusion volume that is wider than it is tall, allowing better lateral spreading of infusion materials such that they may better unfurl, steep, and so on. Such a vessel, according to embodiments, also provides for less risk of undesirably compressing the infusion materials because the same amount of infusion material may rest in a thinner layer at the bottom of the vessel. According to various embodiments, the vessel may have an ergonomic handle that vertically spans substantially all the liquid containing portion of the vessel (e.g., is substantially the same height as the wall of the vessel) for better balance and control of the vessel while pouring the infused liquid.

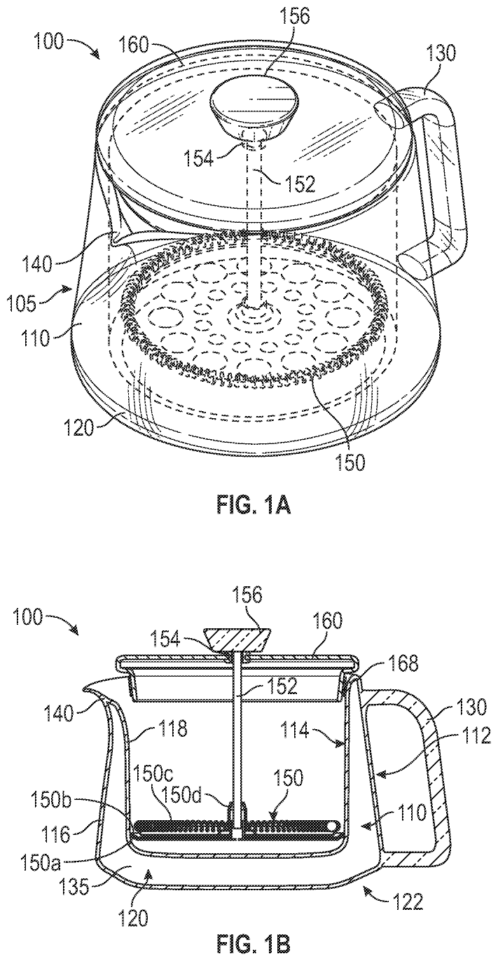

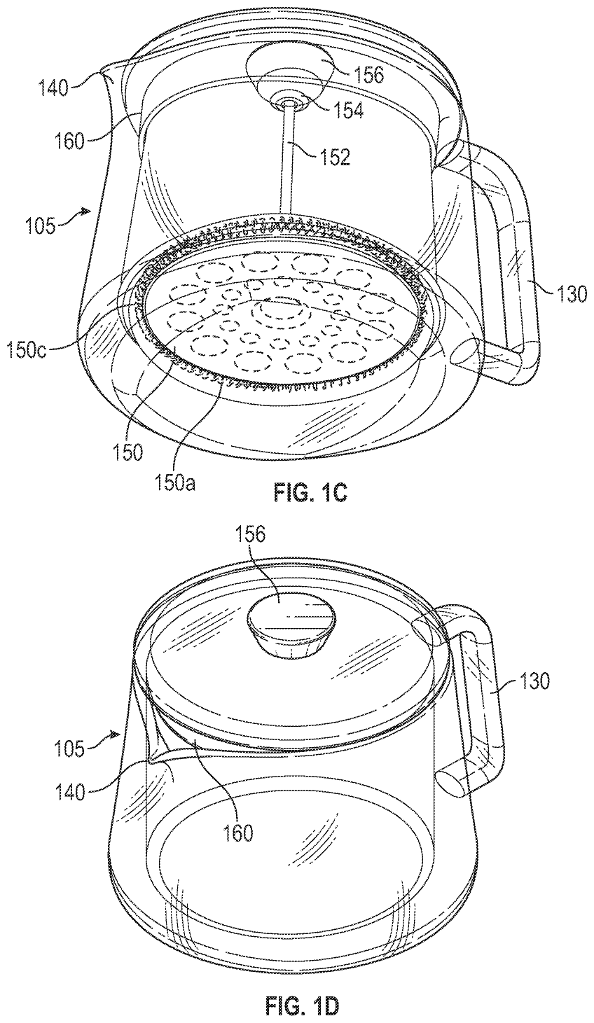

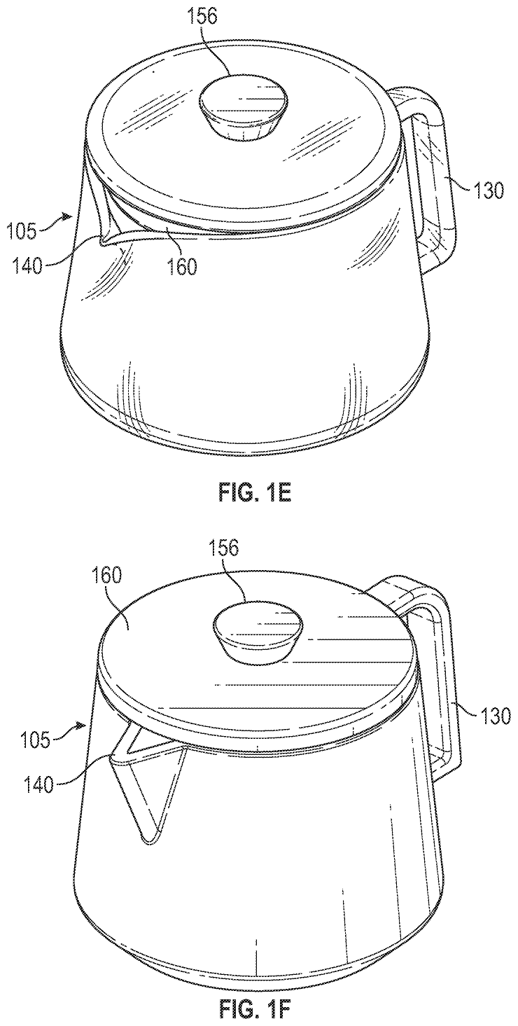

Referring to FIGS. 1A and 1C, a system for creating in infused liquid 100 (otherwise referred to herein as an infusion system) may comprise a vessel 105, a lid 160, and a strainer assembly 150. In some embodiments, the vessel 105 and/or lid 160 may comprise any suitable material to withstand a desired temperature of infused liquid (e.g., boiling or near-boiling water) and any pressure caused by the resistance of the strainer device pushing the infusion material and liquid toward the bottom of the vessel 105. In some embodiments, the vessel 105 and/or lid 160 may comprise glass, ceramic, plastic, polymer, or the like. Referring to FIGS. 1E and 1F, in some embodiments, the vessel 105 and/or lid 160 may comprise an opaque material, for example a ceramic. Referring to FIGS. 1C and 1D, in some embodiments, the vessel 105 and/or lid 160 may comprise substantially transparent colored glass, for example having an amber color, gray color, cream color, white color, clear, or the like. In an exemplary embodiment, the vessel 105 and lid 160 comprise borosilicate glass. In some embodiments, the vessel 105 and/or lid 160 may be sufficiently transparent to provide visibility, through the outer walls, of the inner walls defining the internal volume. In some such embodiments, the vessel 105 and/or lid 160 may be a colored transparent material.

In some embodiments, the vessel 105 and/or lid 160 may have a single wall or double wall construction. Referring to FIG. 1B, in some embodiments, the vessel 105 is double-walled and the lid 160 is single-walled. The double wall may comprise both a base 120 and a wall 110 of the vessel 105, or just the wall 110, and the double wall may comprise an inner wall 118 and an outer wall 116. The double wall construction may provide a gap 135 defining a void between the inner wall 118 and the outer wall 116 and the gap 135 may provide a thermal insulation function. In some embodiments, the gap 135 may contain a vacuum or a gas (e.g., a noble gas) to provide the thermal insulation function. In some embodiments, the gap 135 may comprise a foam, cork, or the like to provide the thermal insulation function.

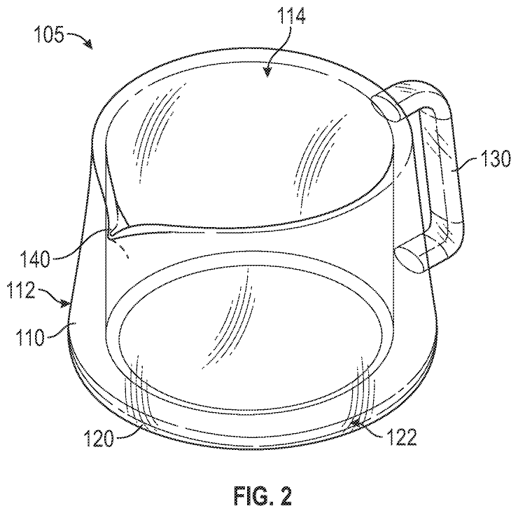

Referring to FIGS. 1B and 2, the vessel 105 may comprise a base 120 and a wall 110 extending upwardly from the base 120. In some embodiments, the base 120 and the wall 110 may be continuously formed or otherwise comprise an uninterrupted medium. The wall 110 of the vessel 105 has an exterior surface 112 and an interior surface 114. In some embodiments, the exterior surface 112 of the wall 110 is substantially non-vertical. In some embodiments, the exterior surface 112 of the wall 110 may comprise a frustoconical surface. For example, the exterior surface 112 of the wall 110 may completely or partially define a frustoconical surface. In an exemplary embodiment, the exterior surface 112 of the wall 110 defines a frustoconical surface except at the upper and lower extent of the wall 110 where the outer wall 116 comprises a curved transition. In some embodiments, the exterior surface 112 of the wall 110 does not comprise a curved profile in the vertical direction (e.g., it may be curved horizontally around a circumference but is substantially flat or otherwise not curved in a vertical direction perpendicular to the circumference). In some embodiments, the exterior surface 112 of the wall 110 does not form a spherical, ovoid, or other similar curved surface that is curved in multiple perpendicular axes. In some embodiments, the exterior surface 112 of the wall 110 may form a slightly curved profile in the vertical direction proximate to the bottom and/or top of the wall 110, for example as a transition into the exterior surface 122 of the base 120.

The interior surface 114 of the wall 110 may be substantially vertical (e.g., substantially perpendicular to a top and/or bottom surface of the base 120) and may define a substantially cylindrical internal volume, which in some embodiments may comprise a slightly frustoconical volume. In some embodiments, the interior surface 114 of the wall 110 may be vertical and may define a cylinder of constant diameter, such that the interior surface 114 of the wall 110 defines a cylindrical internal volume. In various embodiments, the height of the interior volume (defined by the interior surface 114) is not greater than the diameter (or smallest diameter in the case of a frustoconical volume) of the interior volume.

In embodiments where the vessel 105 comprises a double wall vessel having an outer wall 116 on the outside of the vessel 105 and an inner wall 118 on the interior of the vessel 105, the exterior surface 112 of the wall 110 is an exterior surface of the outer wall 116 and the interior surface 114 of the wall 110 is an interior surface of the inner wall 118. In some such embodiments, the outer wall 116 of the wall 110 may be continuous with the outer wall of the base 120 and the inner wall 118 of the wall 110 may be continuous with the inner wall of the base 120.

The lid 160 may be configured to removably couple to the vessel 105 near the top of the wall 110. In some embodiments, the lid 160 may be configured to slidably insert into the upper part of the vessel 105. In some embodiments, the lid 160 may comprise a compressible or otherwise flexible material for providing friction and/or cushioning between the lid 160 and the vessel 105. For example, the lid 160 may comprise an elastomer such as rubber, silicone, or the like. The lid 160 may comprise, for example, a silicone bumper 168, which in some embodiments may be removable and/or replaceable. In some embodiments, the lid 160 may be configured to thread into the top of the vessel 105. In some embodiments, the lid 160 may be configured with a latch closure, hinged attachment, rubber seal, or other suitable mechanisms to attach and/or seal the lid 160 to the vessel 105.

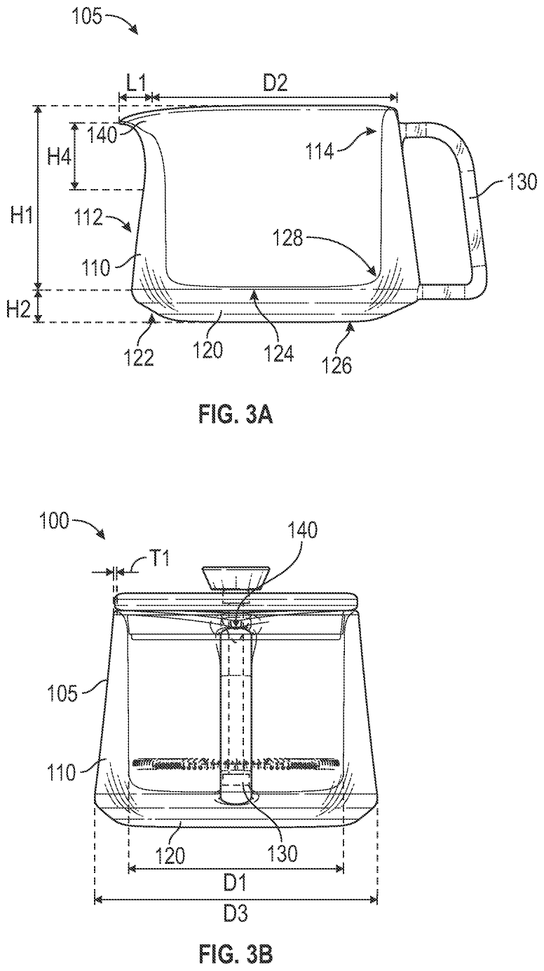

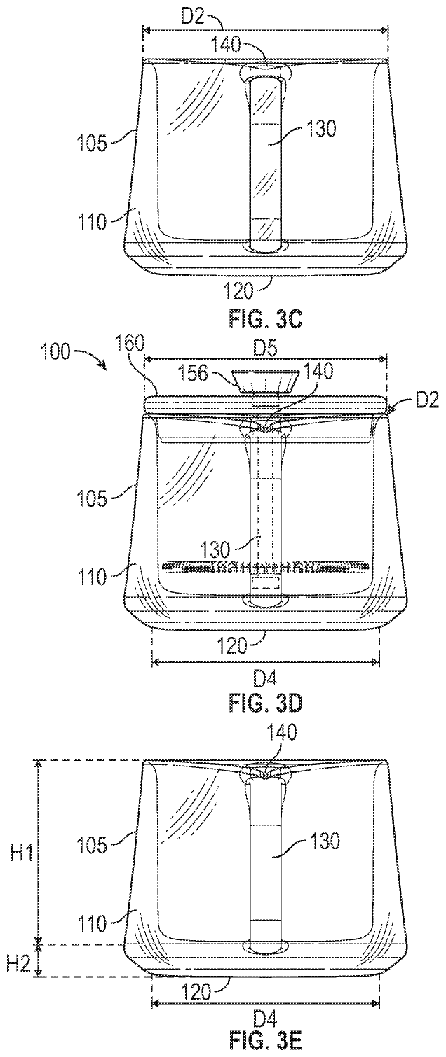

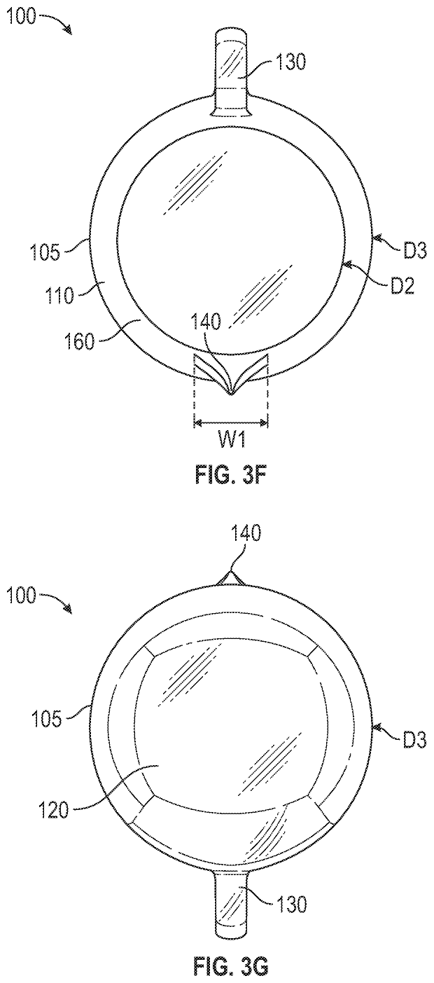

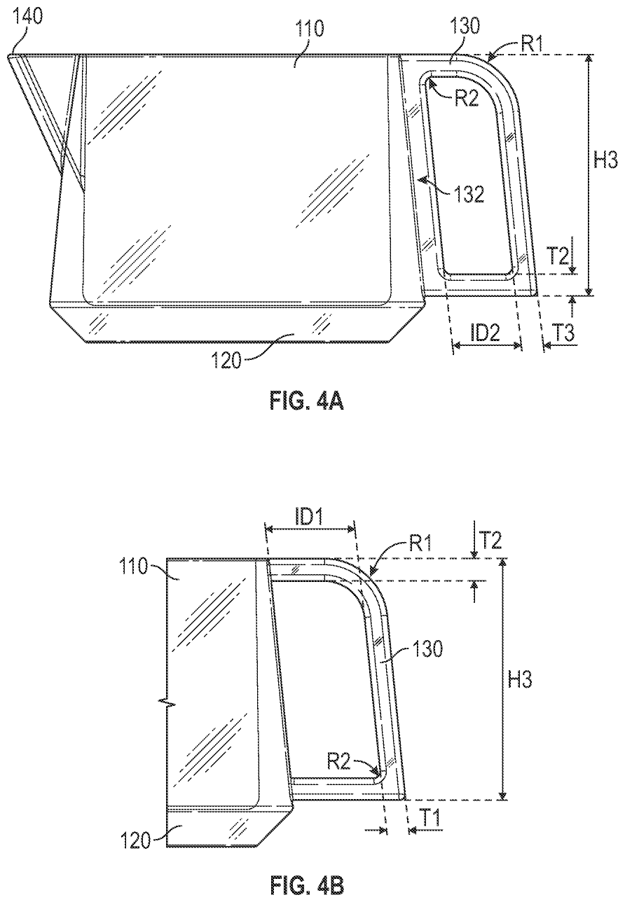

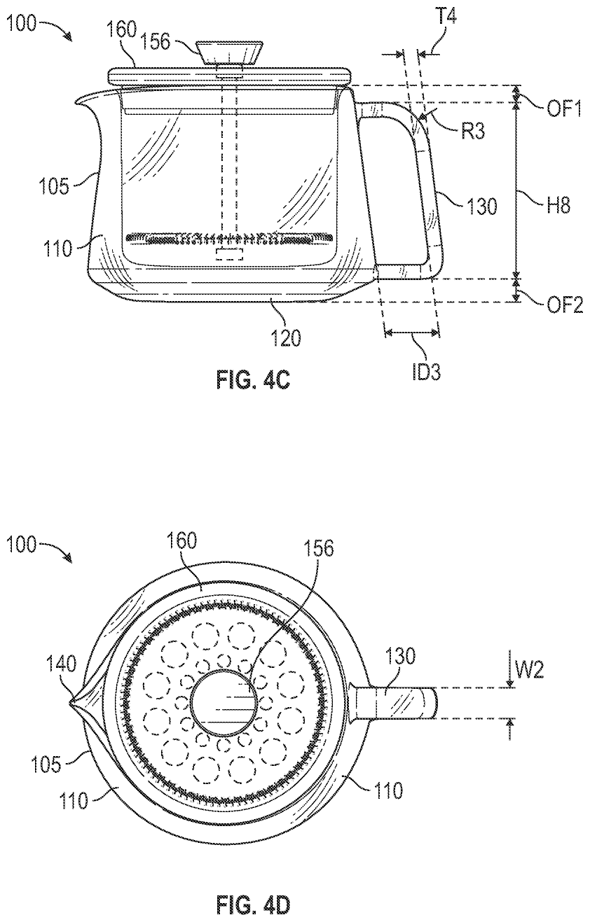

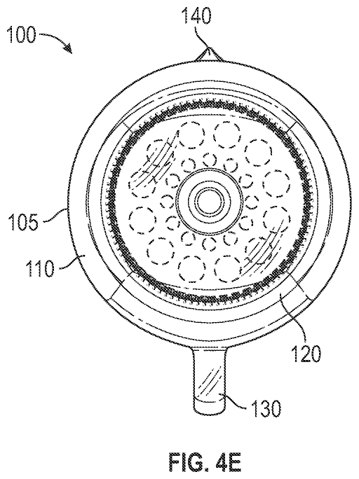

The wall 110 may comprise a spout 140 configured to allow the infused liquid to be poured from within the vessel 105. The spout 140 may be formed continuously with the wall 110. In some embodiments, the spout 140 may be located at an upper portion of the wall 110. Referring briefly to FIGS. 4A and 1F, in some exemplary embodiments, the spout 140 may comprise a V-shaped or pyramidal pouring spout defining a triangular shape when viewed from above. Referring to FIGS. 3A and 3F, in some exemplary embodiments, the spout 140 may comprise a curved V-shaped pouring spout when viewed from above, and when viewed from the side may have a concave lower profile that transitions to a middle portion of the wall 110 and a convex top profile that transitions to the upper extent of the wall 110. In some embodiments, the spout 140 may extend from the upper extent (i.e., the upper reach or top) of the wall 110 toward but not all the way to the lower extent (i.e., the lower reach or bottom, next to the base 120) of the wall 110. In some embodiments, the spout 140 may extend about halfway down the wall 110. In some embodiments, the spout 140 does not have a tubular configuration, for example the spout 140 is not a gooseneck spout. In some embodiments, the spout 140 is not curved, and in some embodiments the spout 140 is only minorly curved where the various planes of the spout 140 meet each other and/or the wall 110.

Referring still to FIGS. 3A and 3F, in some embodiments, the spout 140 may have a width W1 of about 25 millimeters to about 55 millimeters (for example 35 millimeters to 45 millimeters) at the upper extent of the wall 110, a height H4 of about 15 millimeters to about 35 millimeters (for example 20 millimeters to 30 millimeters), and a length L1 of about 15 millimeters to about 35 millimeters (for example 20 millimeters to 30 millimeters) at the upper extent of the wall 110, with the spout 140 tapering down to blend or otherwise meet with the wall at the bottom of the spout 140. In an exemplary embodiment the spout 140 may have a width W1 of about 40 millimeters at the upper extent of the wall 110, a height H4 of about 25 millimeters, and a length L1 of about 25 millimeters at the upper extent of the wall 110, with the spout 140 tapering down to blend or otherwise meet with the wall at the bottom of the spout 140. In some alternative embodiments, the height H4 may be about 40 millimeters to about 60 millimeters, for example 45 millimeters to 55 millimeters, and in some exemplary cases a height H4 of about 50 millimeters.

Referring again to FIGS. 1A, 1B, and 1C, in some embodiments, the strainer assembly 150 may be coupled to a first end of a plunger rod 152. The plunger rod 152 may be inserted into a hole in or near the center of the lid 160, such that the plunger rod 152 is slidably coupled with the lid 160. The hole may further comprise a sealing insert 154 such as a grommet, bushing, or gland of any suitable material (e.g., rubber, nylon, plastic, etc.) through which the plunger rod 152 is inserted. In some embodiments, the sealing insert may provide sealing, supporting, and/or retaining functionality. The second end of the plunger rod 152 may be coupled with a knob 156 or other suitable apparatus that comfortably allows a human hand to push or pull the plunger rod 152 through the lid 160. The plunger rod 152 may be actuated, for example via the knob 156, to move the strainer assembly 150 up or down through the interior of the vessel 105. The plunger rod 152, knob 156, and strainer assembly 150 make up a plunger assembly. The plunger rod 152, knob 156, and/or strainer assembly 150 may comprise any suitable material(s), for example stainless steel or aluminum. In some embodiments, one or more of the plunger rod 152, knob 156, and/or strainer assembly 150 may be powder coated.

The strainer assembly 150 may comprise any suitable arrangement of components that function to separate the desired infusion material from the infused liquid when the strainer assembly 150 is moved through the internal volume. In some embodiments, the strainer assembly may comprise a cross plate 150a, a mesh filter 150b, and a spiral plate 150c. The mesh filter 150b may comprise a mesh having suitably sized openings (e.g., holes, pores, or the like) to allow the liquid to pass through but that prevents the infusion material from passing. The mesh filter 150b may be configured to prevent sediment from the infusion material, down to a predetermined size, from passing. The mesh filter 150b openings may be configured differently depending on the type of infusion material (e.g., coffee grinds, tea leaves, etc.) intended for the infusion system 100.

The cross plate 150a and spiral plate 150c may provide support to the mesh filter 150b, for example to help it substantially maintain its shape as it is moved through the volume. In some embodiments, the mesh filter 150b, supported by the spiral plate 150c and/or cross plate 150a, may maintain a seal with the interior surface 114 of the wall 110. In some embodiments, the strainer assembly 150 may comprise a collet 150d to secure the strainer assembly 150 to the plunger rod 152. The various components of the strainer assembly 150 may comprise any suitable material, for example stainless steel.

Referring to FIGS. 1B and 3A, in some embodiments, the vessel 105 comprises a handle 130. The handle 130 may be coupled with or otherwise formed as part of the wall 110 and/or base 120. In some embodiments, the handle 130 may be attached to the wall 110 without being attached to the base 120. In exemplary embodiments, the handle 130 may extend along substantially the entire height of the wall 110, for example from substantially the upper extent of the exterior surface 112 of the wall 110 to substantially the lower extent of the exterior surface 112 of the wall 110, for example proximate to the base 120. In some embodiments, the handle 130 may extend at least partially to the base 120, for example a lower portion of the handle attaching to both the wall 110 and base 120.

Turning now to FIGS. 3A, 3B, 3C, 3E, 3F, and 3G, the interior surface 114 of the wall 110 has a first diameter D1 and a first height H1 and forms a cylindrical volume having the first diameter D1 and the first height H1. The exterior surface 112 of the wall 110 may also have the first height H1 or may be substantially the same as the first height H1. In some embodiments, the interior surface 114 of the wall 110 may comprise a transition 128 to a top surface 124 of the base 120 using any suitable shape, for example a constant-radius curve, and the cylindrical internal volume may therefore have a corresponding change in shape at its lowest extent near the base 120.

The first height H1 may be smaller than, equal to, or greater than the first diameter D1. In an exemplary embodiment, the first height H1 is smaller than the first diameter D1. In some embodiments, the first height H1 may be between 75 percent and 95 percent of the first diameter D1. In some embodiments, the first height H1 may be between 82 percent and 92 percent of the first diameter D1, for example about 87 percent of the first diameter D1. For example, the first diameter D1 may be about 115 millimeters and the first height H1 may be about 100 millimeters.

The exterior surface 112 of the wall 110 has a second diameter D2 near or at the top of the wall 110. In some exemplary embodiments, the exterior surface 112 has the second diameter D2 at the top of the vessel 105 and the second diameter D2 is greater than the first diameter D1 of the interior surface 114. In some embodiments, the exterior surface 112 has a third diameter D3 near or at the bottom of the wall 110. In some exemplary embodiments, the exterior surface 112 has the third diameter D3 proximate to the base 120, for example at the bottom of the wall 110. In some embodiments, the second diameter D2 and the third diameter D3 are separated (vertically) by the first height H1.

In some embodiments, the third diameter D3 is greater than the second diameter D2, and the third diameter D3 may comprise the widest part of the exterior of the vessel 105. The exterior surface 112 of the wall 110 may gradually increase in diameter from the second diameter D2 to the third diameter D3, except as otherwise required to accommodate for the spout 140 and/or the handle 130. In some embodiments, the gradual increase in diameter of the exterior surface 112 of the wall 110 from the second diameter D2 to the third diameter D3 comprises a linear or substantially linear increase. For example, the exterior surface 112 of the wall 110 may form a substantially frustoconical surface having a circular base of approximately the third diameter D3.

In some embodiments, the base 120 may have a second height H2 (which may also be referred to herein as the depth of the base 120), an exterior surface 122, and a bottom surface 126. The exterior surface 122 of the base 120 may be continuous with or otherwise proximate to the exterior surface 112 of the wall 110. The bottom surface 126 of the base 120 is opposite the top surface 124 of the base 120, with the top surface 124 separated from the bottom surface 126 by the second height H2.

The combined first height H1 and second height H2 (e.g., the total height of the vessel 105) may be smaller than, equal to, or greater than the first diameter D1. In an exemplary embodiment, the combined first height H1 and second height H2 is approximately the same as the first diameter D1. In some embodiments, the combined first height H1 and second height H2 may be between 90 percent and 110 percent of the first diameter D1. In some embodiments, the combined first height H1 and second height H2 may be between 95 percent and 105 percent of the first diameter D1, for example about 100 percent of the first diameter D1. In an exemplary embodiment, the first diameter D1 may be about 115 millimeters, the first height H1 may be about 100 millimeters, and the second height H2 may be about 15 millimeters.

In some embodiments, the exterior surface 122 of the base 120 has the third diameter D3 proximate to the wall 110, for example such that the bottom of the exterior surface 112 of the wall 110 and the top of the exterior surface 122 of the base 120 share the third diameter D3. The exterior surface 122 of the base 120 may have a fourth diameter D4 at a lower extent of the base, for example proximate to the bottom surface 126 of the base 120. In an exemplary embodiment, the exterior surface 122 has the fourth diameter D4 where it meets with the bottom surface 126 of the base 120. In some embodiments, the fourth diameter D4 and the third diameter D3 are separated by the second height H2.

In some embodiments, the fourth diameter D4 is smaller than the third diameter D3. The exterior surface 122 of the base 120 may gradually decrease in diameter from the third diameter D3 to the fourth diameter D4. In some embodiments, the gradual decrease in diameter of the exterior surface 122 of the base 120 from the third diameter D3 to the fourth diameter D4 comprises a linear or substantially linear decrease. For example, the exterior surface 122 of the base 120 may form an upside-down substantially frustoconical surface having a circular base of approximately the third diameter D3. In such embodiments, the exterior surface 122 of the base 120 may comprise (e.g., may completely or partially define) a frustoconical surface. In an exemplary embodiment, the exterior surface 122 of the base 120 defines a frustoconical surface except at the upper and lower extent of the base 120 where the base comprises a curved transition. In some embodiments, the exterior surface 122 of the base 120 does not comprise a curved profile in the vertical direction (e.g., it may be curved horizontally around a circumference but is substantially flat or otherwise not curved in a vertical direction perpendicular to the circumference). In some embodiments, the exterior surface 122 of the base 120 does not form a spherical, ovoid, or other similar curved surface that is curved in multiple perpendicular axes. In some embodiments, the exterior surface 122 of the base 120 may form a slightly curved profile in the vertical direction proximate to the bottom and/or top of the base 120, for example as a transition into the bottom surface 126 of the base 120 and/or exterior surface 112 of the wall 110.

The fourth diameter D4 may be smaller than, equal to, or greater than the second diameter D2 and/or the first diameter D1. In an exemplary embodiment, the fourth diameter D4 is smaller than the second diameter D2. In some embodiments, the fourth diameter D4 is approximately the same as the first diameter D1. In an exemplary embodiment, the fourth diameter D4 is larger than the first diameter D1 by about three to ten percent, for example by about five percent. In an exemplary embodiment, the first diameter D1 is about 115 millimeters, the second diameter D2 is about 130 millimeters, the third diameter D3 is about 150 millimeters, the fourth diameter is about 120 millimeters, the first height H1 is about 100 millimeters, and the second height H2 is about 15 millimeters.

Referring to FIGS. 1B and 3B, the wall 110 and/or base 120 may comprise a wall having a first thickness T1. The wall 110 and/or base 120 may comprise a double wall, wherein each wall (inner wall and outer wall) may have any suitable thickness. In some embodiments, the inner and outer walls have the same first thickness T1. In some embodiments, the first thickness T1 may be about one millimeter to about five millimeters. In an exemplary embodiment, the first thickness T1 may be about two millimeters.

In some embodiments, for example as shown in FIG. 4A, the handle 130 may have a third height H3 and may comprise an attachment segment 132 (an inner segment) that spans the entire height H3 of the handle 130, with the attachment segment 132 being attached (directly or indirectly) to the wall 110. The handle 130 may have any suitable height H3. In some embodiments, the handle 130 may be 90 percent to 100 percent of the first height H1 of the wall 110, for example from about 94 percent to about 98 percent of the first height H1. In some embodiments, the handle 130 may be substantially the same height as the wall 110 of the vessel 105. In an exemplary embodiment, the wall 110 has a first height H1 of about 100 millimeters and the handle 130 has a third height H3 of about 96.5 millimeters.

Still referring to FIG. 4A, the handle 130 may have a second internal depth ID2, a third thickness T3 at an external (or outer) segment of the handle 130, and a second thickness T2 at a bottom segment of the handle 130 and/or upper segment of the handle 130. In some embodiments, the second internal depth ID2 may be about 20 millimeters to about 35 millimeters, for example from about 24 to 30 millimeters. In an exemplary embodiment, the second internal depth ID2 is about 27 millimeters. In some embodiments, the third thickness T3 and the second thickness T2 are the same. In some embodiments, the third thickness T3 and second thickness T2 may be about five percent to about fifteen percent of the third height H3, for example about nine to ten percent of the third height H3. In an exemplary embodiment, with the third height H3 of about 96.5 millimeters, the third thickness T3 and second thickness T2 may be about nine millimeters.

In some embodiments, the upright segments of the handle 130 (the outer segment and the attachment segment) are substantially parallel with the outer surface 112 of the wall 110. In some embodiments, the upper and lower segments of the handle 130 are substantially horizontal, for example parallel with the bottom surface 126 of the base 120. In some embodiments, the handle 130 may comprise a curved upper exterior segment that transitions from the outer segment to the upper segment, wherein the curved upper exterior segment has a first external radius R1. In some embodiments, the handle 130 may have a second internal radius R2 at one or more other interior corners of the handle 130. In some embodiments, the second internal radius R2 may be about five percent to fifteen percent of the first external radius R1, for example about ten percent of the first external radius R1. In an exemplary embodiment, the first external radius R1 may be about 25 millimeters, and the second internal radius may be about 2.5 millimeters. In some embodiments, the lower segment of the handle 130 may have a squared-off transition to the outer segment of the handle 130 and may have an external radius at the transition equal to the second internal radius R2.

In other embodiments, for example as shown in FIG. 4B, the handle 130 may be attached to the wall 110 at the upper and lower segments of the handle 130 with no attachment segment. In these embodiments, the handle 130 may have a first internal depth ID1. In some embodiments, the first internal depth ID1 may be about 29 millimeters to about 44 millimeters, for example from about 33 to 39 millimeters. In an exemplary embodiment, the first internal depth ID1 is about 36 millimeters. The other dimensions and features of the example of FIG. 4B may be the same as described with respect to the example of FIG. 4A. In some embodiments, the top edge of the spout 140, handle 130, and/or wall 110 align with each other (i.e., touch the same horizontal plane).

Referring to FIGS. 4C, 4D, and 4E, in some embodiments, the handle 130 may have an oval cross section. In some embodiments, the handle 130 may have an oval cross section along its entire length, for example through the upper, lower, and external segments of the handle 130. In some embodiments, the upper, lower, and external segments may comprise a continuous material, for example from an oval length of suitable material that is bent to form the various segments. In some embodiments, the upper and lower segments of the handle 130 may be substantially parallel with each other and with a bottom surface 126 and/or top surface 124 of the base 120. In some embodiments, the external segment of the handle may be substantially parallel with the exterior surface 112 of the wall 110.

In some embodiments, for example as shown in FIGS. 4C, 4D, and 4E, the handle 130 may comprise a curved upper exterior segment that transitions from the outer segment to the upper segment, wherein the curved upper exterior segment has a third external radius R3. The third external radius R3 may be about 27 millimeters. The handle 130 may have an eighth height H8 which may be any suitable height. In some embodiments, the eighth height H8 may be about 88 percent to about 100 percent of the first height H1 of the wall 110, for example from about 91 percent to about 97 percent of the first height H1. In some embodiments, the handle 130 may be about 94 percent of the first height H1. In an exemplary embodiment, the wall 110 has a first height H1 of about 100 millimeters and the handle 130 has an eighth height H8 of about 94 millimeters.

In some embodiments, the handle 130 may be vertically offset downward from the top of the wall 110, for example by a first offset OF1, and may have a second offset OF2 from the bottom of the vessel 105. The first offset OF1 may be about five to fifteen percent of the eighth height H8, for example about ten percent. Due to the first offset OF1 and the eight height H8, the lower segment of the handle 130 may join with the vessel 105 partially or completely at the base 120. In an exemplary embodiment, the handle 130 has an eight height H8 of about 94 millimeters, the first height H1 is about 100 millimeters, a first offset OF1 of about 9 millimeters, and a second offset OF2 of about 12 millimeters, such that the lower segment of the handle 130 overlaps with the base 120 by about 3 millimeters.

Still referring to FIGS. 4C, 4D, and 4E, in some embodiments, the handle 130 may have a third internal depth ID3 and a fourth thickness T4. In some embodiments, the third internal depth ID3 may be about 20 millimeters to about 36 millimeters, for example from about 25 to 31 millimeters. In an exemplary embodiment, the third internal depth ID3 is about 28 millimeters. In some embodiments, the third radius R3 may be approximately the same as the third internal depth ID3. In some embodiments, the handle 130 may have the fourth thickness T4 substantially throughout the entire handle, for example in the upper, lower, and external segments. In some embodiments, the fourth thickness T4 may be about three percent to about fourteen percent of the eighth height H8, for example about eight to nine percent of the eighth height H8. In an exemplary embodiment, with the eighth height H8 of about 94 millimeters, the fourth thickness T4 may be about eight millimeters.

Referring to FIG. 4D, the handle 130 may have any suitable width. In some embodiments, the handle 130 may have a second width W2 that is about one to three times the fourth thickness T4, for example about twice the fourth thickness T4. In an exemplary embodiment, where the fourth thickness T4 is about 8 millimeters, the second width W2 may be about 17 millimeters.

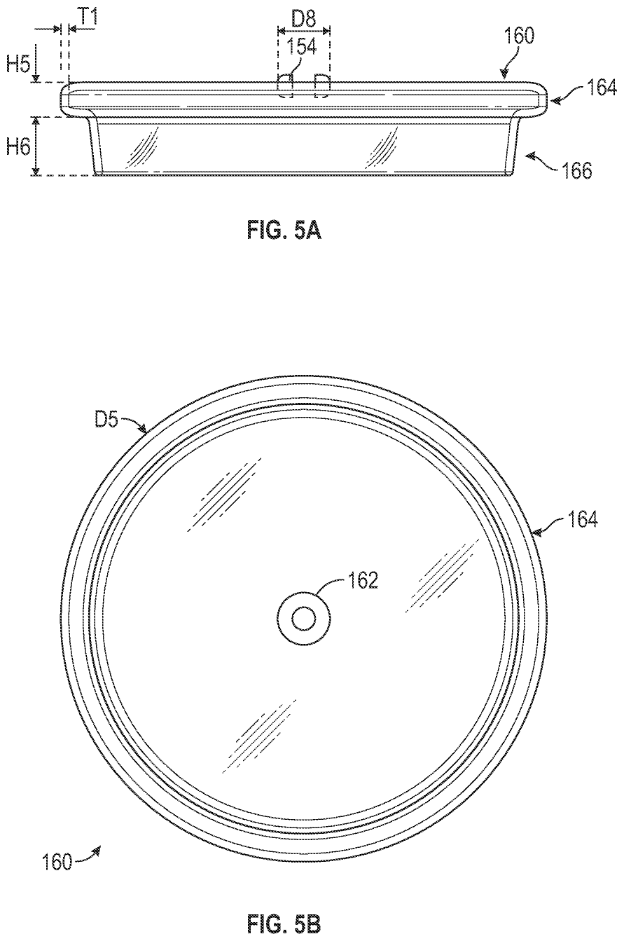

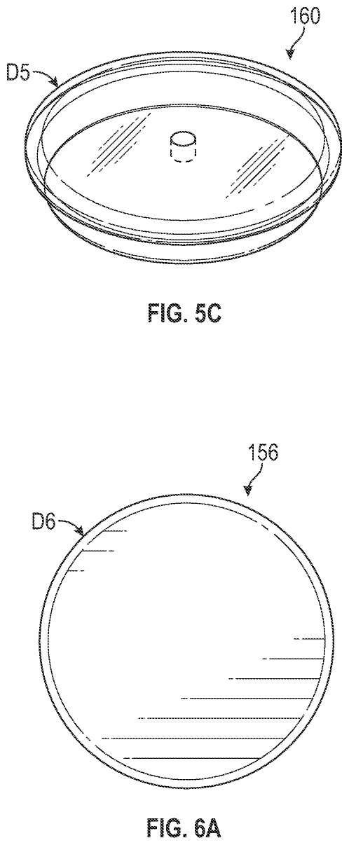

Referring to FIGS. 5A, 5B, and 5C, in some embodiments the lid 160 may comprise an insertion portion 166 and a lip portion 164. The insertion portion 166 may be configured to slidably insert into or otherwise couple with the upper part of the vessel 105, and the lip portion may be configured to rest on top of the wall 110 of the vessel 105 or otherwise sit on or stand proud of the top of the vessel 105. The lip portion 164 may have a fifth height H5 and the insertion portion may have a sixth height H6. In some embodiments, the insertion portion 166 may have a height H6 of about 5 to about 25 millimeters, for example from about 10 millimeters to about 20 millimeters. In an exemplary embodiment, the sixth height H6 is about 15 millimeters. In some embodiments, the lip portion 164 may have a height H5 of about 1 to about 20 millimeters, for example from about 5 millimeters to about 15 millimeters. In an exemplary embodiment, the fifth height H5 is about 10 millimeters.

The insertion portion 166 may have any suitable diameter to allow it to insert into or otherwise couple with the upper part of the vessel 105. In some embodiments, the insertion portion 166 may have substantially the same diameter as first diameter D1, for example slightly smaller than the first diameter D1 to allow insertion of the insertion portion 166 into the vessel 105. In some embodiments, the diameter of the insertion portion 166 may slightly decrease, for example with a curved profile, from its intersection with the lip portion 164 to the bottom of the insertion portion 166 (for example forming a frustoconical surface).

Referring briefly also to FIG. 3D, the lip portion 164 may have any suitable diameter to allow it to rest on top of the wall 110 or otherwise sit on the vessel 105. In some embodiments, the lip portion 164 may have a fifth diameter D5. In some embodiments, the fifth diameter D5 is greater than the diameter of the insertion portion 166. In some embodiments, the fifth diameter D5 is approximately the same as the second diameter D2. In some embodiments, the fifth diameter D5 may be about 110 milliliters to about 130 millimeters, for example from about 115 millimeters to about 125 millimeters. In an exemplary embodiment, the fifth diameter D5 and the second diameter D2 are about 130 millimeters.

In some embodiments, the lip portion 164 has the fifth diameter at the lower edge of the lip portion 164 proximate to the insertion portion 166, with the diameter gradually decreasing from the lower edge to an upper edge of the lip portion 164. In some embodiments, the gradual decrease in diameter is a linear decrease. For example, the exterior surface of the lip portion 164 may form a frustoconical surface having a circular base of the fifth diameter D5. In some embodiments, the linear decrease is the same linear decrease as from the third diameter D3 to the second diameter D2 of the wall 110, such that the exterior surface of the lip portion 164 is parallel to the exterior surface 112 of the wall 110. In some embodiments, the fifth diameter D5 is approximately the same as the second diameter, such that the exterior surface of the lip portion 164 and the exterior surface 112 of the wall 110 share substantially the same frustoconical surface.

In some embodiments, the lid 160 may have a wall thickness approximately the same as the first thickness T1. In an exemplary embodiment, the lid 160 has a wall thickness of about two millimeters. In some embodiments, the lid 160 may have a centrally located opening 162 (e.g., a hole) to receive the plunger rod 152 and/or sealing insert 154. The opening 162 may define a cylindrical volume through all or part of the lid 160, for example having the fifth height H5. The opening 162 may have an eighth diameter D8, which may be for example from about 5 millimeters to about 15 millimeters, for example about 9.5 millimeters. The eighth diameter D8 may be large enough to accommodate the plunger rod 152 (which may, for example, have a diameter of about 8 millimeters+/−25%) and the sealing insert 154.

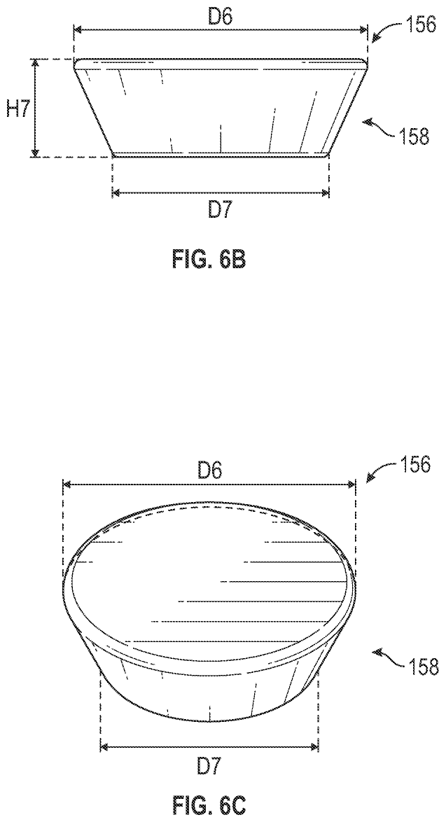

Referring to FIGS. 6A, 6B, and 6C, in some embodiments the knob 156 may have a seventh height H7, an exterior surface 158, and an attachment portion (not shown) at the bottom of the knob for attaching to the plunger rod 152. The attachment portion may comprise any suitable attachment structure, for example a hole designed to press fit the plunger rod 152, screw threads, a glue interface, weld, or the like. In some embodiments, the shape of the knob 156 may imitate the shape of the base 120. In some embodiments, an exterior surface 158 of the knob 156 has a sixth diameter D6 at the upper portion (e.g., at the top) of the knob 156 and a seventh diameter D7 at the lower portion (e.g., at the bottom) of the knob 156. In some embodiments, the sixth diameter D6 and the seventh diameter D7 are separated by the seventh height H7.

In some embodiments, the seventh diameter D7 is smaller than the sixth diameter D6. The exterior surface 158 of the knob 156 may gradually decrease in diameter from the sixth diameter D6 to the seventh diameter D7. In some embodiments, the gradual decrease in diameter of the exterior surface 158 of the knob 156 from the sixth diameter D6 to the seventh diameter D7 is a substantially linear decrease. For example, the exterior surface 158 of the knob 156 may form an upside-down substantially frustoconical surface having a circular base of the sixth diameter D6.

In some embodiments, the sixth diameter D6 may be about 20 to about 52 millimeters, for example about 31 millimeters to about 41 millimeters. In an exemplary embodiment, the sixth diameter D6 is about 36 millimeters. In some embodiments, the seventh diameter D7 may be about 10 to about 44 millimeters, for example about 22 millimeters to about 32 millimeters. In an exemplary embodiment, the seventh diameter D7 is about 27 millimeters. In some embodiments, the seventh height H7 is about 5 millimeters to about 20 millimeters, for example about 8 millimeters to about 16 millimeters. In an exemplary embodiment, the seventh height H7 is about 12 millimeters.

In some embodiments, the exterior surface 158 of the knob 156 does not comprise a curved profile in the vertical direction (e.g., it may be curved horizontally around a circumference but is not curved in a vertical direction perpendicular to the circumference). In some embodiments, the exterior surface 158 of the knob 156 does not form a spherical, ovoid, or other similar curved surface that is curved in multiple perpendicular axes. In some embodiments, the exterior surface 128 of the knob 156 may form a slightly curved profile in the vertical direction proximate to the bottom and/or top of the knob 126, for example as a transition to the top and/or bottom of the knob 126.

Dimensional and other measurement references given herein with “approximately,” “about,” or the like encompass manufacturing and other design tolerances and adjustments, and therefore may include a variation from the given dimension or measurement reference of plus or minus ten percent.

The term “exemplary” is used herein to represent one example, instance, or illustration that may have any number of alternates. Any implementation described herein as “exemplary” should not necessarily be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A system for creating an infused liquid, comprising:
a vessel having a base and a wall extending upwardly from the base to a first height, wherein:
an interior surface of the wall is substantially vertical and defines a cylindrical internal volume having a first diameter and substantially the first height;
the vessel comprises a spout at an upper portion of the wall;
the vessel comprises a handle on an exterior surface of the wall; and
an exterior surface of the wall has a second diameter substantially at an upper extent of the wall and a third diameter proximate to the base, wherein:
the third diameter is greater than the second diameter; and
the exterior surface of the wall gradually increases in diameter from the second diameter to the third diameter;
a strainer assembly comprising a mesh filter, wherein the strainer assembly is configured to be inserted within the internal volume and wherein a diameter of the mesh filter is configured to be received by the internal volume;
a plunger rod having a first end and a second end, wherein the first end is coupled with the strainer assembly; and
a lid configured to removably couple with the wall near the upper extent of the wall, wherein the lid comprises an opening slidably coupled with the plunger rod.

2. The system of claim 1, wherein the handle extends vertically along at least 80 percent of the exterior surface of the wall and couples, at a lower extent of the handle, to the wall proximate to the base.

3. The system of claim 1, wherein the wall is a double wall structure comprising an inner wall and an outer wall, wherein:
the exterior surface of the wall is an exterior surface of the outer wall and the interior surface of the wall is an interior surface of the inner wall.

4. The system of claim 1, wherein the base has a first depth and an exterior surface of the base has the third diameter proximate to the wall and a fourth diameter at a lower extent of the base, wherein the fourth diameter is smaller than the third diameter and wherein the exterior surface of the base gradually decreases in diameter from the third diameter to the fourth diameter.

5. The system of claim 4, wherein the gradual increase in diameter of the exterior surface of the wall comprises a linear increase from substantially the second diameter to substantially the third diameter and wherein the gradual decrease in the diameter of the exterior surface of the base comprises a substantially linear decrease.

6. The system of claim 4, wherein the fourth diameter is less than the second diameter.

7. The system of claim 6, wherein the first diameter is about 115 millimeters, the second diameter is about 130 millimeters, the third diameter is about 150 millimeters, and the fourth diameter about 120 millimeters.

8. The system of claim 1, wherein the first height is less than the first diameter.

9. The system of claim 8, wherein the first height is about 100 millimeters and the first diameter is about 115 millimeters.

10. A device for creating an infused liquid, comprising:
a vessel having a base and a wall extending upwardly from the base to a first height, wherein:
an interior surface of the wall is substantially vertical and defines a cylindrical internal volume having a first diameter and substantially the first height;
the vessel comprises a spout at an upper portion of the wall;
the vessel comprises a handle on an exterior surface of the wall; and
an exterior surface of the wall has a second diameter substantially at an upper extent of the wall and a third diameter proximate to the base, wherein:
the third diameter is greater than the second diameter; and
the exterior surface of the wall gradually increases in diameter from the second diameter to the third diameter.

11. The device of claim 10, wherein the wall is a double wall structure comprising an inner wall and an outer wall, wherein:
the exterior surface of the wall is an exterior surface of the outer wall and the interior surface of the wall is an interior surface of the inner wall.

12. The device of claim 10, wherein the base has a first depth and an exterior surface of the base has the third diameter proximate to the wall and a fourth diameter at a lower extent of the base, wherein the fourth diameter is smaller than the third diameter and wherein the exterior surface of the base gradually decreases in diameter from the third diameter to the fourth diameter, and wherein:
the gradual increase in diameter of the exterior surface of the wall comprises a linear increase from substantially the second diameter to substantially the third diameter and the exterior surface of the wall comprises a frustoconical surface; and
the gradual decrease in the diameter of the exterior surface of the base comprises a substantially linear decrease and the exterior surface of the base comprises a frustoconical surface.

13. The device of claim 12, wherein the first diameter is about 115 millimeters, the second diameter is about 130 millimeters, this third diameter is about 150 millimeters, and the fourth diameter about 120 millimeters.

14. The device of claim 10, wherein the first height is less than the first diameter.

15. The device of claim 14, wherein the first height is about 100 millimeters and the first diameter is about 115 millimeters.

16. A device for creating an infused liquid, comprising:
a vessel having a base and a wall extending upwardly from the base to a first height, wherein:
an interior surface of the wall is substantially vertical and defines a cylindrical internal volume having a first diameter and substantially the first height;
an exterior surface of the wall comprises a first frustoconical surface and comprises a second diameter at a top of the wall and a third diameter at a bottom of the wall, wherein the second diameter is smaller than the third diameter;
an exterior surface of the base comprises a second frustoconical surface and comprises the third diameter at a top of the base and a fourth diameter at a bottom of the base, wherein the fourth diameter is small than the third diameter and wherein the first frustoconical surface transitions to the second frustoconical surface at the third diameter;
the vessel comprises a spout at an upper portion of the wall;
the vessel comprises a handle on an exterior surface of the wall; and
the first height is less than the first diameter.

17. The device of claim 16, wherein:
the base has a first depth;
the vessel has a total height equal to the first height plus the first depth; and
the total height is equal to the first diameter.

18. The device of claim 16, wherein the wall is a double wall structure comprising an inner wall and an outer wall, wherein:
the exterior surface of the wall is an exterior surface of the outer wall and the interior surface of the wall is an interior surface of the inner wall.

19. The device of claim 16, wherein the first diameter is about 115 millimeters, the second diameter is about 130 millimeters, the third diameter is about 150 millimeters, and the fourth diameter about 120 millimeters.

20. The device of claim 19, wherein the first height is about 100 millimeters.
